(19) United States
(12) Patent Application Publication
(10) Pub. No.: US 2013/0290214 A1
(43) Pub. Date: Oct. 31, 2013

(54) METHOD AND APPARATUS FOR PROVIDING REVIEWS AND FEEDBACK FOR PROFESSIONAL SERVICE PROVIDERS

(71) Applicant: Robert James Clavin, Newburgh, NY (US)

(72) Inventor: Robert James Clavin, Newburgh, NY (US)

(21) Appl. No.: 13/456,105

(22) Filed: Apr. 25, 2012

(51) Int. Cl. G06Q 30/00

(52) U.S. Cl. 705/347

(57) ABSTRACT

The present invention relates generally to a method and an apparatus for providing reviews and feedback for professional service providers (PSP). More particularly, the invention encompasses a method and an apparatus for providing reviews and feedback on customers or organizations by a professional service provider who has worked with the customer or the organization. The present invention is also directed to one or more data bases that are accessible to professional service providers either prior to or during or after performing a work assignment for a specific customer or organization. The present invention also encompasses a rating system and/or reviews by a professional service provider either prior to or during or after performing a work assignment for a specific customer, on not only for the job but also on the client or customer. Ads for generating income could also be displayed or transmitted during any communication.

### FIELD OF THE INVENTION

The present invention relates generally to a method and an apparatus for providing reviews and feedback for professional service providers (PSP). More particularly, the invention encompasses a method and an apparatus for providing reviews and feedback on customers or organizations by a professional service provider who has worked with the customer or the organization. The present invention is also directed to one or more data bases that are accessible to professional service providers either prior to or during or after performing a work assignment for a specific customer or organization. The present invention also encompasses a rating system and/or reviews by a professional service provider either prior to or during or after performing a work assignment for a specific customer, on not only for the job but also on the client or customer. Ads for generating income could also be displayed or transmitted during any communication.

### BACKGROUND INFORMATION

Various efforts have been done in the past to provide information for services, products, and reviews, but they have had limited success.

U.S. Pat. No. 7,099,859 (Neelakantan Sundaresan), the entire disclosure of which is incorporated herein by reference, discloses a computer program product which is provided as a business rating system to rank business that are relevant to a given Internet search topic. Business ratings are stored in a ranking repository that can be optionally searched by the user along with a user-defined search engine query. The business ratings are compiled from off-line surveys provided for example by independent agencies and/or other off-line surveys obtained through web based rating services. The business ratings can optionally be compiled from on-line questionnaires attached to the search engine results. The business ratings assess the quality of the businesses in terms of “interactive” criteria such as customer satisfaction, professionalism, and cost and ease of use of the businesses products or services. The business rating system is comprised of an indexing engine, a query transformer, a search results transformer, a ranking based result sorter, an off-line ranking system, a metadata repository, and a ranking repository. The business rating system integrates the ratings with the search results, and ranks the search results based on such business ratings. In this manner, the user of a search engine receives feedback from other users about businesses of interest. Eventually, businesses with higher ratings will be ranked at the top of the search list, while business with lower ratings will be ranked lower.

U.S. Pat. No. 7,337,133 (Jeffrey P. Bezos, et al.), the entire disclosure of which is incorporated herein by reference, discloses in an Internet-based customer referral system which enables individuals and other business entities (“associates”) to refer customers to a merchant's web site in return for compensation, such as commissions on resulting sales. Entities initially register with the merchant web site as associates, and are provided with instructions for creating links to the merchant web site. An associate may, for example, set up an associate web site (or other information dissemination system) with reviews, recommendations, and/or editorials of specific products in the merchant's online catalog, together with links to associated pages in the catalog. When a user follows such a link and then makes a purchase (as tracked by the merchant web site), the system preferably awards a commission to the associate. The system also preferably generates feedback reports that provide each associate with data regarding the effectiveness of each link provided by that associate.

U.S. Pat. No. 7,483,842 (Kin Chung Fung, et al.), the entire disclosure of which is incorporated herein by reference, discloses that in a retail business environment, sales employees interact with customers and generate retail sales. Employee skills, product knowledge, and performance are particularly relevant to sales generated, and hence to cash flow. Periodic assessments are typically performed to monitor the progress and growth of the business and to identify areas of strength and flag potential weaknesses. Such assessments typically take the form of sales data outlining generated revenue, for example, gross receipts or the net profit of a particular employee or store. A system for measuring and analyzing performance data including collecting data indicative of performance and analyzing the data to compute an aggregate synopsis of performance of an employee provides quantitative data for providing employee specific feedback and direction to the employee for improving performance. A hypothesis is formed from the aggregate synopsis to determine one or more actions, such as training and skill practice, directed to improving performance. The determined actions are pursued with the employee under evaluation, and a change in the performance as a result of applying the actions is measured. Measurement and analysis is repeated in an iterative manner to continually assess and develop employee skills toward increased performance and hence, increased sales.

U.S. Pat. No. 7,747,648 (Reiner Kraft, et al.), the entire disclosure of which is incorporated herein by reference, discloses systems and methods for information retrieval and communication employ a world model. The world model is made up of interrelated entity models, each of which corresponds to an entity in the real world, such as a person, place, business, other tangible thing, community, event, or thought. Each entity model provides a communication channel via which a user can contact a real-world person responsible for that entity model. Entity models also provide feedback information, enabling users to easily share their experiences and opinions of the corresponding real-world entity.

U.S. Pat. No. 7,809,602 (Rand B. Nickerson, et al.), the entire disclosure of which is incorporated herein by reference, discloses according to one embodiment, a computer-implemented method for measuring and reporting business intelligence based on comments collected from web page users using software associated with accessed web pages includes: using a computer system, accessing a plurality of user comments collected from users of one or more web pages using feedback collection software that provides users who access a particular web page a viewable element through which to provide their comments regarding one or more aspects of a business associated with the particular web page; using a computer system, associating each of the plurality of collected user comments with one or more of a plurality of predefined business-related categories; and using a computer system, generating a report identifying, for each of the plurality of predefined business-related categories, one or more quantitative values derived from the collected user comments associated with that business-related category.

U.S. Pat. No. 7,853,479 (Rick Robert Bengson), the entire disclosure of which is incorporated herein by reference, discloses certain embodiments of the present invention that provide a system for collecting and disseminating customer and agent data, distributing real estate marketing literature, issuing literature vouchers, issuing commission receipts, and sending follow-up emails to solicit feedback data. The system includes a customer terminal, which is in communication with a data center, which, in turn, is in communication with a business terminal. The customer terminal includes a device for inputting customer and agent data and a device for distributing relevant marketing literature and issuing literature vouchers and commission receipts. The customer and agent data is sent to the data center, where it is stored for subsequent retrieval by a salesperson using the business terminal. The data center automatically generates and sends follow-up emails to the customer and agent to solicit feedback data. When the feedback data is received, the data center updates the relevant customer and agent data with the feedback data.

U.S. Pat. No. 8,024,367 (Thomas Heinzel, et al.), the entire disclosure of which is incorporated herein by reference, discloses methods and systems for managing alerts in a database that are provided, whereby the alerts originate from at least one business application due to exceptional situations, and whereby the alerts are represented as objects, each object corresponding to one of a number of configurable alert types. Each of the alert type may be configured, so that alerts of that alert type comprise at least one of: an ID for uniquely identifying the alert, information representative of the type of alert, message text being descriptive of the alert, a set of parameters representative of business or control objects associated with the alert, an alert scope being representative of the relevance for partners or users, feedback information being representative of time and identity of acknowledging the alert by a partner or user, status information for controlling follow-up actions, validity time information, and priority information.

U.S. Pat. No. 8,095,457 (Stephen M. Polston, et al.), the entire disclosure of which is incorporated herein by reference, where a computerized system and method are presented for exchanging information between a buyer, a seller, a lender, and a strategic business source. The system permits sellers, lenders and strategic business sources to input buyers that are then submitted for activation. The buyers use the system to obtain information about items, while the sellers, lenders, and strategic business sources make consistent contact with the buyer in order to work with the buyer. Information about the buyers is shared with the sellers, lenders, and strategic business sources. A business plan is input into the system for the financial institution employing the lender while another business plan is input for the seller institution employing the seller. Activity on the computerized system is calculated for compliance with the business plan. Feedback is provided to management relating to whether the business plan is being met.

U.S. Pat. No. 8,112,327 (Guangrong Ying), the entire disclosure of which is incorporated herein by reference, the invention discloses a method and system of bi-directional marketing with feedback, comprising: building up a consuming net system that promotes the business between customer and seller. The consuming net system signs a contract with customer, then the consumer built up, on the other hand, said system signs contract with seller, then the provider built up. The consuming net system receives commission from the provider and returns interest to the consumer according to the contract. The method and system adds the steps of interest distributing and information distributing during circulate service, so that customer can get balanced information during consuming, and also he can get balanced interest. The present invention changes the way of information dissemination and unfair distributing system. It eludes the economic crisis at all.

U.S. Patent Publication No. 2006/0253316 (Peter E. Blackshaw, et al.), the entire disclosure of which is incorporated herein by reference, which comprises methods and apparatus to collect data associated with a consumer through generation of a consumer feedback communication via a wide area network. A business to which the consumer feedback communication is directed is identified in response to input from a consumer via the wide area network. Feedback data relating to the business is obtained from the consumer via the wide area network. At least a portion of the consumer feedback communication is automatically generated using the feedback data. Data associated with the consumer is then collected from the obtained feedback data.

U.S. Patent Publication No. 2007/0106688 (Wen-YiChang, et al.), the entire disclosure of which is incorporated herein by reference, where a network-based data feedback processing method and system is proposed, which is designed for use in conjunction with a network system, and which is characterized by the capability of feeding the data stored in the database of a material dispatching management system on a data server on a remote side back to an ERP management system on a business-side server on a local side, for the purpose of allowing all the related working personnel of a business organization, such as purchase personnel, inventory management personnel, accounting personnel, and so on, to inquire into the feedback data via their own ERP management system. This feature can help enhance the efficiency of custom-related works in the enterprise.

U.S. Patent Publication No. 2007/0124184 (Michael R. Schmit, et al.), the entire disclosure of which is incorporated herein by reference, discloses in one embodiment a method of organizing a business to align goals of the business with goals of customers of the business and accelerate value creation for both the business and the customers of the business, the method comprising: identifying one or more experiences of customers of a business, wherein the one or more experiences are selected from the group consisting of the customers' value discovery experience, the customers' buying decision experience, the customers' ordering experience, the customers' receiving experience, the customers' using experience, the customers' payment experience, and the customers' feedback and problem resolution experience; organizing the business under a process management system for one or more of the customer experiences wherein each process management system comprises a process owner, a documenting process, formal process review, identification of customer driven measures and methods for process evaluation and improvement; gathering customer feedback regarding one or more of the customer experiences; and based on the customer feedback regarding one or more of the customer experiences, modifying the one or more process management systems associated with the customer experience to improve the one or more customer experiences.

U.S. Patent Publication No. 2007/0156505 (Shai Agassi, et al.), the entire disclosure of which is incorporated herein by reference, where methods and systems for providing feedback on business transactions using computer applications are provided. A method for providing feedback on sponsored content effectiveness includes collecting purchasing information for purchases by a user of a computer application in response to display of sponsored content in the computer application. The purchasing information is provided to a provider of the sponsored content.

U.S. Patent Publication No. 2007/0299715 (George J. Brucato), the entire disclosure of which is incorporated herein by reference, discloses a method and system for receiving feedback information concerning customers. Business users are permitted to provide information concerning customer infractions to a web-site maintained on a server. In one embodiment, that information is utilized to determine a score for the particular customer. Information concerning a customer's score may be accessed by other business users and, in one embodiment, by customers as well.

U.S. Patent Publication No. 2008/0097769 (Brian W. Galvin, et al.), the entire disclosure of which is incorporated herein by reference, discloses methods and systems of customer feedback include collecting customer feedback while the customer is physically located in a retail environment, transmitting the customer feedback through a wireless communication facility to a data processing facility, wherein the data processing facility automatically compares the customer feedback to at least one threshold value in accordance to a business rule to determine an alert action, and communicating a message to an employee of an enterprise associated with the retail environment. Customer feedback is also collected by a payment transaction facility including a touch screen display adapted to present transaction information and receive a signature. A customer query is presented on the touch screen display along with selectable answers to collect customer feedback.

U.S. Patent Publication No. 2011/0213724 (Srinath Nagarajan, et al.), the entire disclosure of which is incorporated herein by reference, where a business review application provides a customer with a bank-hosted business review platform that provides an advertising and feedback service for the bank's business customers and provides a rating, review, feedback, and recommendation service for the bank's individual and business customers. Thus, the bank's customers can rate and review the bank's business customers. The bank uses its authentication systems used by its customers to access online banking services to authenticate the identity of the customer creating a business review in the business review platform. In some embodiments, the business review application only permits its customers to make one review of a business within a certain period of time or one review after a transaction with that business shows up in the customer's transaction information maintained by the bank. In this way, the bank can host a review platform that is much more accurate and trust-worthy than traditional business review platforms.

This invention improves on the deficiencies of the prior art and provides an inventive method and an apparatus for providing reviews and feedback for professional service providers (PSP).

### PURPOSES AND SUMMARY OF THE INVENTION

The invention is a method and an apparatus for providing reviews and feedback for professional service providers (PSP).

Therefore, one purpose of this invention is to provide a cost effective method and apparatus for providing reviews and feedback for professional service providers (PSP).

Another purpose of this invention is to provide a method and an apparatus for providing reviews and feedback on customers by a professional service provider who has worked with the customer.

Yet another purpose of this invention is to provide one or more data bases that are accessible to professional service providers either prior to or after performing a work assignment for a specific customer.

Still yet another purpose of this invention is to provide a rating system by a professional service provider either prior to or after performing a work assignment for a specific customer, on not only for the job but also on the client or customer.

Therefore, in one aspect this invention comprises an apparatus for providing information over a network comprising:

(a) at least one central data base connected to said network, said at least one central data base comprising at least one first means for processing said information;
(b) at least one first professional service provider inputting at least one first review based on a first work done for at least one first customer into said at least one central data base;
(c) at least one second means in said at least one central data base to associate said at least one first review with said information;
(d) at least one second professional service provider requesting information from said at least one central data base on said at least one first customer; and
(e) wherein said information sent to said at least one second professional service provider further comprises said at least one first review based on said first work done for said at least one first customer.

In another aspect this invention comprises a method for providing information over a network comprising:

(a) connecting at least one central data base to said network, wherein said at least one central data base comprises of at least one first means for processing said information;
(b) providing at least one first input from at least one first professional service provider into said at least one central data base, wherein said at least one first input comprises of at least one first review based on first work done for at least one first customer;
(c) associating said at least one first review with said information using at least one second means in said at least one central data base;
(d) providing information to at least one second professional service provider upon request from said at least one second professional service provider based on information contained in said at least one central data base on said at least one first customer; and
(e) wherein said information provided to said at least one second professional service provider comprises of said at least one first review based on said first work done for said at least one first customer.

In yet another aspect this invention comprises a program storage device readable by machine, tangibly embodying a program of instructions executable by the machine to perform method steps for providing information over a network, the method steps comprising:

(a) connecting at least one central data base to said network, wherein said at least one central data base comprises of at least one first means for processing said information;
(b) providing at least one first input from at least one first professional service provider into said at least one central data base, wherein said at least one first input comprises of at least one first review based on first work done for at least one first customer;
(c) associating said at least one first review with said information using at least one second means in said at least one central data base;
(d) providing information to at least one second professional service provider upon request from said at least one second professional service provider based on information contained in said at least one central data base on said at least one first customer; and
(e) wherein said information provided to said at least one second professional service provider comprises of said at least one first review based on said first work done for said at least one first customer.

In still yet another aspect this invention comprises a system for providing information over a network comprising:

(a) connecting at least one central data base to said network, wherein said at least one central data base comprises of at least one first means for processing said information;
(b) providing at least one first input from at least one first professional service provider into said at least one central data base, wherein said at least one first input comprises of at least one first review based on first work done for at least one first customer;
(c) associating said at least one first review with said information using at least one second means in said at least one central data base;
(d) providing information to at least one second professional service provider upon request from said at least one second professional service provider based on information contained in said at least one central data base on said at least one first customer; and
(e) wherein said information provided to said at least one second professional service provider comprises of said at least one first review based on said first work done for said at least one first customer.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1, illustrates a flow chart of a first embodiment of the invention.

FIG. 2, illustrates a flow chart of a second embodiment of the invention.

FIG. 3, illustrates a flow chart of a third embodiment of the invention.

FIG. 4, illustrates a flow chart of a fourth embodiment of the invention.

FIG. 5, illustrates a flow chart of a fifth embodiment of the invention.

FIG. 6, illustrates a flow chart of a sixth embodiment of the invention.

FIG. 7, illustrates a flow chart of a seventh embodiment of the invention.

### DETAILED DESCRIPTION

The invention in one aspect is directed to a website or platform that is preferably dedicated for business professional. The website could be termed “For Business Professional, by Business Professionals”. One of the purposes of this website is for the business professional to place reviews, comments and ratings about their customers so that other business professionals may look up what other business professionals have to say about specific individual customers or clients or patients or organizations or companies that they have provided service to.

The inventive concept also allows the worker or workers who actually did the job assignment to get to rate the customer and/or the experience. Thus, this will not only help the first business professional to review and rate their customers, but will also help future business professionals who get to interact with the same customer and/or organization.

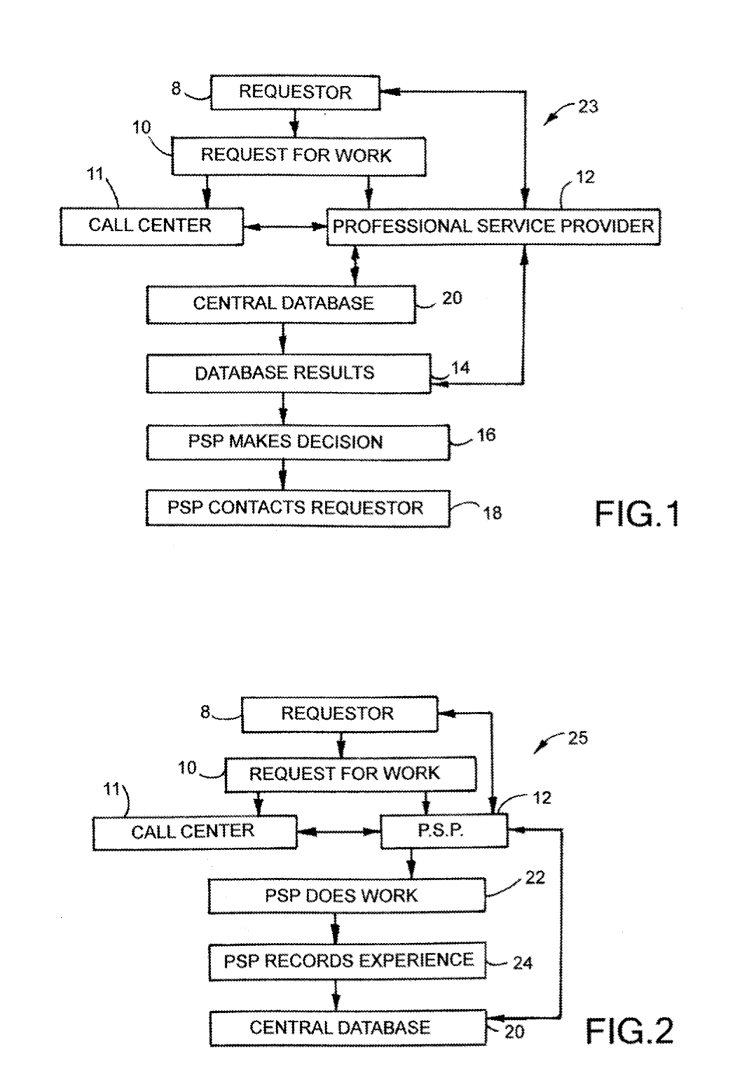

FIG. 1, illustrates a flow chart of a first embodiment 23, of the invention. A request for work 10, from a potential customer or organization or requestor 8, is received at step 10. This request for work 10, from a potential customer or organization 8, that is received at step 10, could be directly to a professional service provider (PSP) 12, or to a call center 11, or it could be directly solicited by the professional service provider 12, from the requestor 8. If the information for the work request 10, from a potential customer or organization 8, is received via the call center 11, then that information would be transmitted to the professional service provider 12, via means well known in the art, such as, via a call center, a telephone, via text, via email, via a verbal conversation, via a smart device, via electronic communication, via verbal communication, via non-verbal communication, a combination thereof, or any other form of communication, to name a few. The request for work 10, from a potential customer or organization 8, that is received by the professional service provider (PSP) 12, may be sufficient or the professional service provider 12, may have to directly contact the requestor 8, in order to obtain any missing or additional information. Once the professional service provider 12, has determined that the requested information is sufficient then the professional service provider 12, would enter the information into a central data base 20, and then request input from the central data base 20. Results from the central data base 20, would be obtained at step 14, and would directly be provided to the professional service provider 12. Based on the information that is provided to the professional service provider 12, at step 14, the professional service provider 12, would then make a decision at step 16, whether or not to accept the requested job assignment and/or what the terms and conditions would be reasonable to accept the requested job 10, or request for work 10, and the decision of the professional service provider 12, would then be directly conveyed to the requestor 8, at step 18.

FIG. 2, illustrates a flow chart of a second embodiment 25, of the invention. A request for work 10, from a potential customer or organization or requestor 8, is received at step 10. This request for work 10, from a potential customer or organization 8, that is received at step 10, could be directly sent to a professional service provider (PSP) 12, or to a call center 11, or it could be directly solicited by the professional service provider 12, from the requestor 8. If the information for the work request 10, from a potential customer or organization 8, is received via the call center 11, then that information would be transmitted to the professional service provider 12, via means well known in the art, such as, via a telephone, via text, via email, via a verbal conversation, via a smart device, or via any other form of communication, to name a few. The request for work 10, from a potential customer or organization 8, that is received by the professional service provider (PSP) 12, may be Sufficient or the professional service provider 12, may have to directly contact the requestor 8, in order to obtain any missing or additional information. Once the professional service provider 12, has determined that the request information is sufficient then the professional service provider 12, would bid on the requested work and perform the requested work at step 22. After completing the requested work 10, from the requestor 8, the professional service provider 12, would prepare a record of the work experience at 24, and then enter it into the central data base 20. The professional service provider 12, could also place reviews, comments, ratings about the customers, on the central data base 20, during, before, or after the request for work 10, has been completed, as that would allow not only the professional service provider 12, but any other business professional 12, who may get a request to do new or any follow-up work 10, by the requestor 8, or at the job site managed by the requestor 8, to look up what other business professionals 12, have to say about a specific individual customer 8, or client 8, or patient 8, or organization 8.

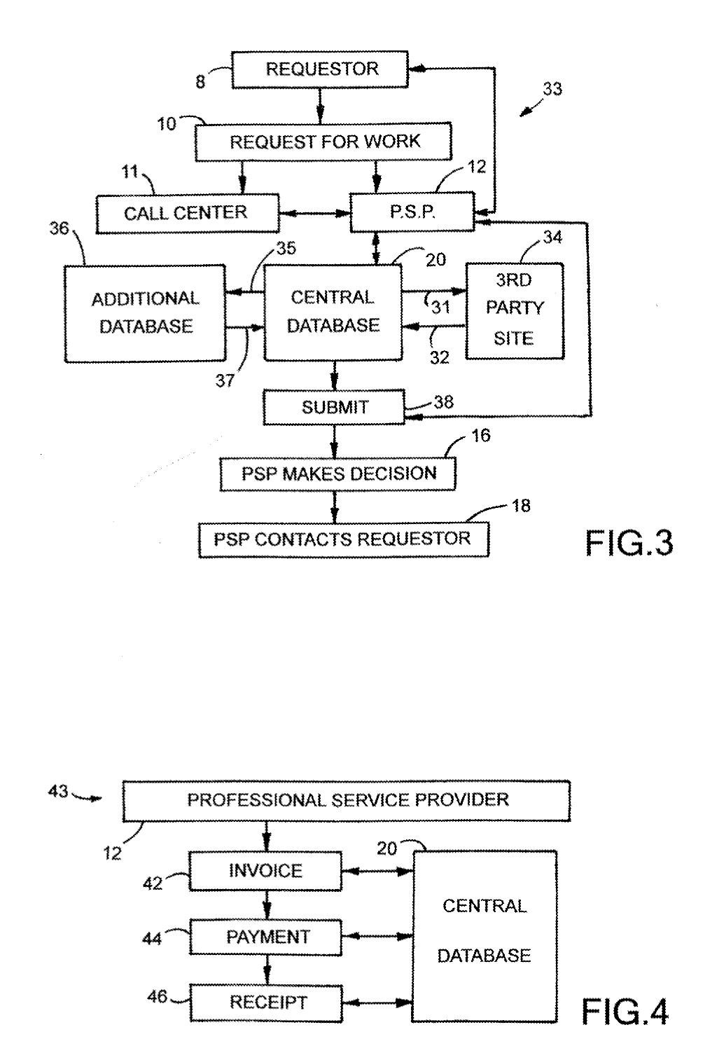

FIG. 3, illustrates a flow chart of a third embodiment 33, of the invention. A request for work 10, from a potential customer or organization or requestor 8, is received at step 10. This request for work 10, from a potential customer or organization 8, that is received at step 10, could be directly sent or transmitted to a professional service provider (PSP) 12, or to a call center 11, or it could be directly solicited by the professional service provider 12, from the requestor 8. If the information for the work request 10, from a potential customer or organization 8, is received via the call center 11, then that information would be transmitted to the professional service provider 12, via means well known in the art, such as, via a telephone, via text, via email, via a verbal conversation, via a smart device, or via any other form of communication, to name a few. The request for work 10, from a potential customer or organization 8, that is received by the professional service provider (PSP) 12, may be sufficient or the professional service provider 12, may have to directly contact the requestor 8, in order to obtain any missing or additional information. Once the professional service provider 12, has determined that the requested information is sufficient then the professional service provider 12, would enter the information into a central data base 20, and then request input from the central data base 20. The central data base 20, in turn would access a third party data base or site 34, and provide the third party data base or site 34, with the information received from the potential customer or organization 8, which may have been supplemented by the professional service provider 12, via step 31. The third party data base or site 34, reviews the submitted information via step 31, and provides any additional information that may not be contained in the request 31, via step 32. Optionally, the additional or supplemental information 32, may then be submitted to one or more additional data bases or websites 36, via step 35, to obtain any missing or additional information from the one or more additional data bases or websites 36, via step 37. The central data base 20, then compiles all the received information and submits it to the professional service provider 12, via step 38. Compiled results from the central data base 20, obtained at step 38, are then directly provided to the professional service provider 12, and that would then allow the professional service provider 12, to make a decision at step 16, FIG. 1, whether or not to accept the requested job assignment and/or what the terms and conditions would be reasonable to accept the requested job, and the decision of the professional service provider 12, would then be directly conveyed to the requestor 8, at step 18, as more clearly illustrated in FIG. 1.

FIG. 4, illustrates a flow chart of a fourth embodiment 43, of the invention. After the job or the work assignment has been completed by the professional service provider 12, the professional service provider 12, would then prepare an invoice at step 42. The invoice 42, that is prepared at step 42, could be a pre-prepared invoice 42, or a customized invoice 42. However, in each case the various fields of the invoice 42, could be pre-populated from information that is either stored in the central data base 20, or information provided by the central data base 20. The invoice from step 42, would then be submitted to the requestor 8, and the requested 8, would then make the payment at step 44, via any of the means, such as, PayPal, credit card payment, debt card payment, payment via a check, electronic payment, payment via electronic fund transfer, and payment via cash, to name a few. Once the payment at step 44, has been received and recorded within the central data base 20, a receipt would be issued to the requestor 8, at step 46. It should be appreciated that both the invoice at step 42, and the receipt at step 46, are also recorded in the central data base 20.

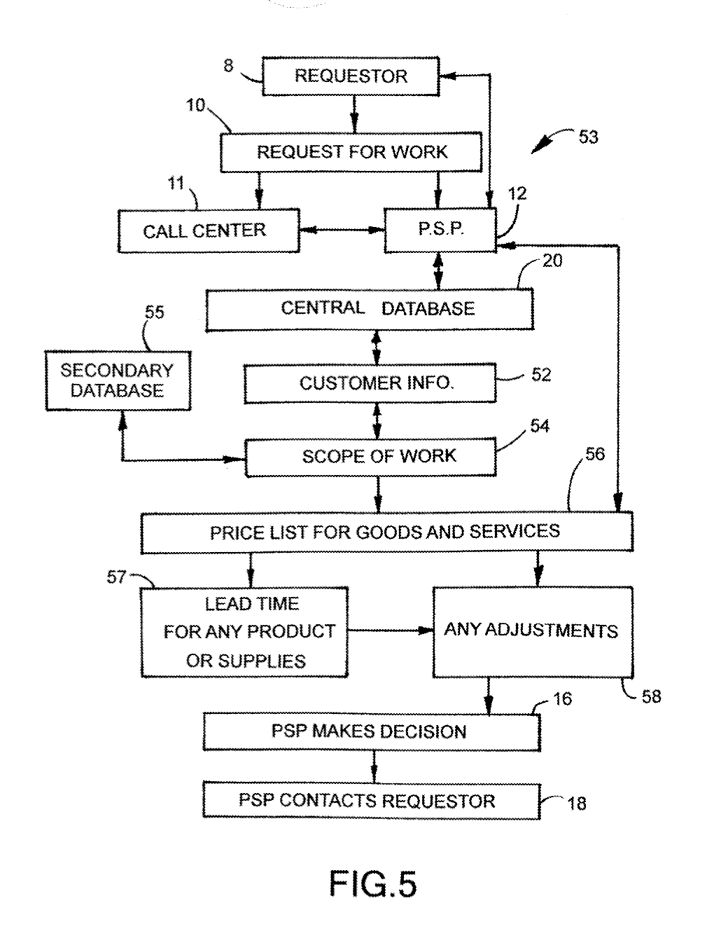

FIG. 5, illustrates a flow chart of a fifth embodiment 53, of the invention. A request for work 10, from a potential customer or organization or requestor 8, is received at step 10. This request for work 10, from a potential customer or organization 8, that is received at step 10, could be sent or transmitted directly to a professional service provider (PSP) 12, or to a call center 11, or it could be directly solicited by the professional service provider 12, from the requestor 8. If the information for the work request 10, from a potential customer or organization 8, is received via the call center 11, then that information would be transmitted to the professional service provider 12, via means well known in the art, such as, via a telephone, via text, via email, via a verbal conversation, via a smart device, or via any other form of communication, to name a few. The request for work 10, from a potential customer or organization 8, that is received by the professional service provider 12, may be sufficient or the professional service provider 12, may have to directly contact the requestor 8, in order to obtain any missing or additional information. Once the professional service provider 12, has determined that the requested information is sufficient then the professional service provider 12, would enter the information into a central data base 20, and then request input from the central data base 20. At step 52, the central data base 20, would look up any information on requestor 8, that it may have or obtain it from a third party source, as discussed with reference to FIG. 3, or from any secondary database, website, or provider 55. The central data base 20, would also access a library or another site or data base at step 54, to assess the scope of work that is being requested 10, by the requestor 8. There may be a field within the central data base 20, where the professional service provider 12, could indicate whether this is a standard work order 10, or a customized work order 10. Based on the gathered or compiled information a price list for services to be rendered or the costs for any goods or services that need to be provided a suggested price list for services or material would be generated at step 56, and provided to the professional services provider 12. The professional services provider 12, could then either further adjust the work order, or the invoice list, and then would submit the same to the requestor 8. Optionally, the central data base 20, could also have access to a supplier of goods or services website or database 57, which could help the professional services provider 12, with any lead times that may be necessary to obtain any of the goods or services for the work requested by the requestor 8. Based on the information that is provided to the professional service provider 12, at step 58, the professional service provider 12, would then make a decision at step 16, whether or not to accept the requested job assignment and/or what the terms and conditions would be reasonable to accept the requested job, and the decision of the professional service provider 12, would then be directly conveyed to the requestor 8, at step 18.

FIG. 6, illustrates a flow chart of a sixth embodiment 63, of the invention. A request for work 10, from a potential customer or organization or requestor 8, is received at step 10. This request for work 10, from a potential customer or organization 8, that is received at step 10, could be directly sent or transmitted to a professional service provider (PSP) 12, or to a call center 11, or it could be directly solicited by the professional service provider 12, from the requestor 8. If the information for the work request 10, from a potential customer or organization 8, is received via the call center 11, then that information would be transmitted to the professional service provider 12, via means well known in the art, such as, via a telephone, via text, via email, via a verbal conversation, via a smart device, or via any other form of communication, and combinations thereof, to name a few. The request for work from a potential customer or organization 8, that is received by the professional service provider (PSP) 12, may be sufficient or the professional service provider 12, may have to directly contact the requestor 8, in order to obtain any missing or additional information. Once the professional service provider 12, has determined that the requested information is sufficient then the professional service provider 12, would enter the information into a central data base 20, and then request input from the central data base 20. The central data base 20, in turn would access a third party data base or site 34, and provide the third party data base or site 34, with the information received from the potential customer or organization 8, which may have been supplemented by the professional service provider 12, via step 31. The third party data base or site 34, reviews the submitted information via step 31, and provides any additional information that may not be contained in the request 31, via step 32. Optionally, the additional or supplemental information 32, may then be submitted to one or more additional data bases or websites 36, via step 35, to obtain any missing or additional information from the one or more additional data bases or websites 36, via step 37. The central data base 20, then compiles all the received information and submits it to the professional service provider 12, via step 64, which would include all the compiled information on the requestor 8, including any prior recorded experience of any professional service provided from step 24, FIG. 2. Compiled results from the central data base 20, and any additional or supplemental information obtained at step 64, is then directly provided to the professional service provider 12, and that would then allow the professional service provider 12, to review the scope of the work 54, in light of the compiled information from step 64. The professional service provider 12, would then make a decision at step 16, FIG. 1, whether or not to accept the requested job assignment and/or what the terms and conditions would be reasonable to accept the requested job or work 10, and the decision of the professional service provider 12, would then be directly conveyed to the requestor 8, at step 18.

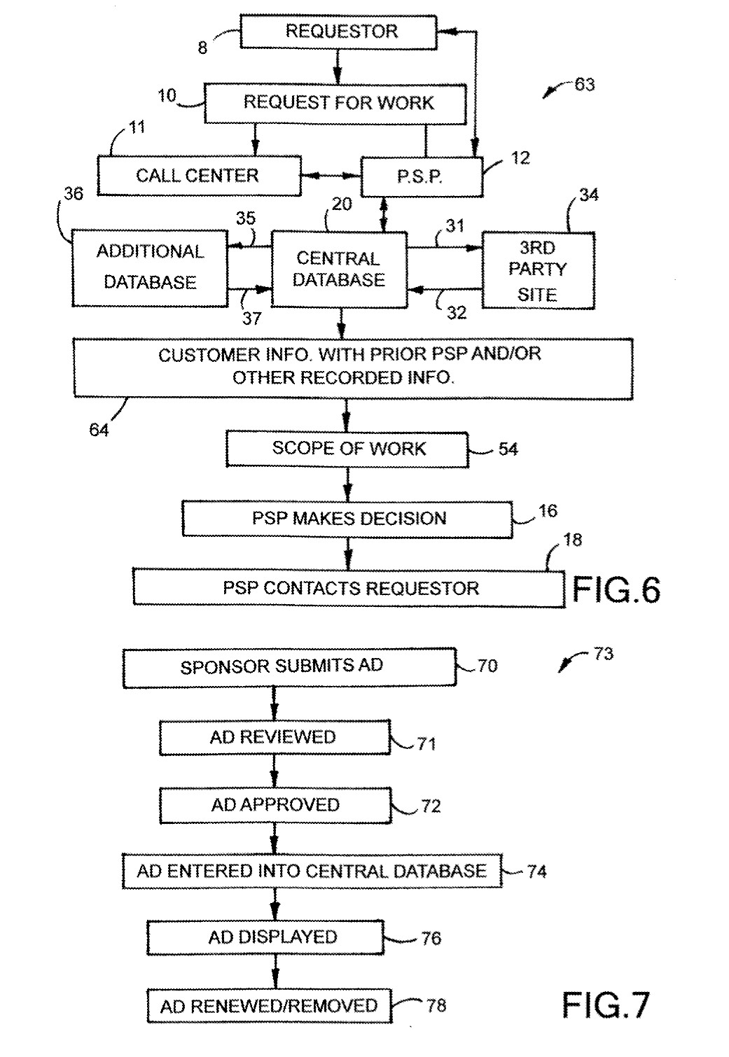

FIG. 7, illustrates a flow chart of a seventh embodiment 73, of the invention, which could be an operator or owner 73, of the central data base 20. A sponsor 70, would submit an ad for display or advertisement at step 70, to the operator or owner 73, of the central data base 20. The owner 73, would review the ad at step 71, and once approved at step 72, or the approved ad 72, would then be entered into the central data base 20, at step 74. The approved ad 72, would then be transmitted or displayed at step 76. The transmission or display of the approved ad 72, at step 76, could be at any time and during any communication between any of the steps outlined in FIGS. 1 through 6. The approved ad 72, would continue to be displayed or transmitted per any agreement between the owner 73, and the sponsor of the ad at step 70, until it is renewed or terminated or removed at step 78. The approved ad 72, could be a public service announcement 72, or it could be a paid approved ad 72. The monies that are generated and/or collected from a paid approved ad 72, are well known in the art, and thus are not being discussed here.

The third party data base or website 34, could populate the requested information, such as, for example, complete name and address of the requestor 8, telephone or mobile number of the requestor 8, maps and/or direction to the job site that has been requested by the requestor 8, any unique identifier or characteristics that might help the professional service provider 12, to name a few.

This inventive website 23, 25, 33, 43, 53, 63, 73, could be a paid service strictly for businesses to sign-up and receive an annual subscription which would allow them to have a computer generated password, at which time they would chose a personal user ID and protected password to access their account. The business professional could be required to fill out an application to be submitted for a nominal fee, and then could provide proof of a current business license and/or business certificate. This inventive website 23, 25, 33, 43, 53, 63, 73, will preferably be for anyone that is legally in business.

The business professional 12, would be able to log into their account through a call center, any Internet or web-enabled device, or obtain access via any form of communication, which are well known in the art, and will be able to read and/or post reviews and comments about any of their customers using the customer's name, address, telephone number, or any other identifying information, as a way of delineating them. The business professional 12, would also be able to rate their customers 8, or the job 8, 10, or any aspect of the work or job assignment into a rating category, such as, a numerical number, for example, from a 1 to a 5 star. For example, a one star would be for a customer 8, who is not a nice customer 8, or refused to pay after the work 10, that was done, or a difficult to work with customer 8, or a very demanding customer 8, to name a few. Similarly, a five stars would be reserved for a great customer, who is a pleasure to do business with, and that they would gladly do work for him/her/them again, a customer 8, who was prompt in making payment for the work 10, that was done, or a customer 8, whose work request 10, was clear, to name a few. Such information would be entered into the central data base 20, via the professional service provider recorded experience at step 24, FIG. 2.

The professional service provider recorded experience at step 24, FIG. 2, on the customer 8, or organization 8, could be done prior to performing the requested work 10, during performance of the requested work 10, or after completing the requested work 10. The professional service provider recorded experience at step 24, FIG. 2, could also include recording any information relating to the scope of the work 54, and that recording of information into the central data base 20, or any other recording data base 20, or device 20, could be done prior to performing the request for work 10, during the performance of the requested work 10, or after completing the requested work 10.

The website 23, 25, 33, 43, 53, 63, 73, will preferably be available on any Internet or web-enabled device. It is currently envisioned that this website 23, 25, 33, 43, 53, 63, 73, will not only be available to professionals and professional organizations in all 50 states, but all the different countries. It could be local, regional, statewide or national for business professionals 12, to use and review their customers 8, and/or organizations 8.

In another aspect the various business professionals 8, 12, and/or organizations 8, 12, would be allowed to buy advertising space on the website 23, 25, 33, 43, 53, 63, 73, to advertise their specific business to other business professional services or products. This would also allow other business professionals 8, 12, to not only refer potential clients 8, but also collaborate on certain specific projects.

The inventive website 23, 25, 33, 43, 53, 63, 73, could allow business professional 12, to accept payment for a project or for their services through any media, such as, PayPal, a major credit card, debit card, electronic fund transfer, and combinations thereof, to name a few.

The inventive website 23, 25, 33, 43, 53, 63, 73, could also have links to other Internet bases providers or services, such as, for example, Facebook, Twitter, You Tube, Linked-In, YellowBook, YellowPages, WhitePages, business directories, customer listing data bases, Mapquest, Dun and Bradstreet, credit reporting companies, and customer information providing data bases, to name a few. Similarly, for example, Facebook, Twitter, You Tube, Linked-In, YellowBook, YellowPages, WhitePages, business directories, customer listing data bases, Mapquest, Dun and Bradstreet, credit reporting companies, and customer information providing data bases, and combinations thereof, to name a few, could be used as the third party site 34, or the additional data base 36.

The access to the inventive website 23, 25, 33, 43, 53, 63, 73, for the professional service provider 12, could be based on a membership, pay-per-click for the requested service, limited access, or similar such combination, to name a few.

The inventive website 23, 25, 33, 43, 53, 63, 73, could operate under the uniform resource locator or universal resource locator (URL) www.CheckYourCustomer.com or similar other website or URL.

It should be appreciated that the requestor 8, could be any individual 8, or an organization 8, or a company 8. Similarly, the professional service provider 12, could be any professional service provider 12, such as, a plumber 12, an electrician 12, a mason 12, a dentist 12, an attorney 12, an automobile mechanic 12, a car sales person 12, just to name a few. Additionally, the request for work 10, could be any type of request for work 10, which a professional service provider 12, could legally provide. Furthermore, the call center 11, could be a traditional call center 11, or an electronic data receiving center 11, or any kind of system 11, which has the capability of receiving information for a request for work 10, and then be able to transmit or transfer the information received for request for work 10, onto a professional service provider 12.

It should be appreciated that any entry made by the requestor 8, or at the call center 11, or by the professional service provider 12, or during any phase of communication between one entity and another entity, could be subject to review and/or approval. This would ensure that no disparaging or degrading or irrelevant information or entry is made at any step of this inventive process, into any of the fields or data bases, by anyone. This would also ensure that quality and relevant information is being provided to anyone, especially, the professional service provider 12, and also from one professional service provider 12, to another professional service provider 12.

Even though FIGS. 1-7 are presented in a particular sequence it is within the realm of a person skilled in the art to change and/or modify the sequence or the steps. Additionally, it should be understood that features presented in one figure can easily be integrated and/or combined with features presented in any of the other figures.

It should be understood that the central data base 20, once operational could be used by other organizations and businesses as they could be provided with access to the information in the data base 20, under specific terms and conditions. It could be similar in scope as for example, third party data base 34, additional data base 36, or secondary data base 55, and combinations thereof, to name a few.

The central data base 20, is a growing data base 20, and thus it is preferred that all added information be saved, including all transmissions and communications. This will not only provide the administrator of the data base 20, to not only archive the information contained in the data base 20, but also be able to supplement it with any additional information.

One advantage of the central data base 20, is that it contains all the necessary information for the professional service provider 12, and thus in case of any nonpayment by the customer 8, for the requested work 10, could be easily and promptly sent to a Credit Reporting company 34, 36. The option to allow the professional service provider 12, to leave feedback directly with the credit bureau 34, 36, could be for an added fee, or it could be a part of their annual dues, or part of their membership, to name a few.

Similarly, the requestor 8, or customer 8, could also have the option to provide supplemental information based on the review or feedback from the professional service provider 12. This would be important, especially in situations where there is a dispute or the requestor 8, and the professional service provider 12, have a disagreement, and thus both party's feedback or review could be recorded into the central data base 20, and a subsequent user 12, of the central data base 20, information could make their own independent evaluation of the two feedbacks or review and comments.

The professional service provider 12, could optionally be offered the opportunity to be referred to a company, such as, for example, a collection agency, an attorney, or any other source that would expedite the collection of the debt that needs to be collected. This service could be for a fee, or a part of their membership fee, or part of an agreement between the service provider 12, of the central data base 20, and the professional service provider 12. Similarly, the collection agency, attorney, or similar such service provider, who is on a list or a preferred list to provide such service to the professional service provider 12, could be made to pay a fee, or it could be a part of their membership fee, or it could be a part of an agreement between the service provider 12, of the central data base 20, and the collection agency, attorney, or similar such service provider.

The administration 20, of the central data base 20, could also offer the professional service provider 12, with different levels of services. For example, the professional service provider 12, could have the option of purchasing a basic plan with a limited number of requests to the central data base 20, information. However, the professional service provider 12, could also have the option to upgrade to a 2nd service plan for an additional amount of money which would allow more requests and/or greater services while utilizing the central data base 20, and the various supporting components. However, for an additional fee/cost the professional service provider 12, could be provided an unlimited request and/or unlimited services to access the central data base 20, and the various supporting components.

It should be understood that the administrator 20, of the central data base 20, could provide different levels of access or security to the professional service provider 12. For example, the security level could limit or allow access to different amounts of information contained within the central data base 20, and the various supporting components. This limitation or access could be based on a fee or the track record of the professional service provider 12, or any criteria developed by the administrator 20, of the central data base 20.

In one aspect the invention also comprises of a business professional interaction with a customer, where the business professional would log onto a website, such as, for example, www.CheckYourCustomer.com using any web enabled type device and post a review or post or blog about the customer after he/she has done work for that particular customer. This information as stated earlier would be stored in the central database. Later on same or another business professional could log onto the website, such as, for example, www.CheckYourCustomer.com using any web enabled type device and review any and/or all the previous posts or reviews or blogs, about the particular customer in question, before, during, or after, the subsequent business professional does any work for that particular customer.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus for providing information over a network comprising:
(a) at least one central data base connected to said network, said at least one central data base comprising at least one first means for processing said information;
(b) at least one first professional service provider inputting at least one first review based on a first work done for at least one first customer into said at least one central data base;
(c) at least one second means in said at least one central data base to associate said at least one first review with said information;
(d) at least one second professional service provider requesting information from said at least one central data base on said at least one first customer; and
(e) wherein said information sent to said at least one second professional service provider further comprises said at least one first review based on said first work done for said at least one first customer.

2. The apparatus for providing information over a network of claim 1, wherein said at least one first customer contacts said at least one first service provider via a method selected from a group consisting of a call center, a smart phone, a telephone, text, email, electronic communication, verbal communication, non-verbal communication, and combinations thereof.

3. The apparatus for providing information over a network of claim 1, wherein said at least one first means for processing said information in said at least one central data base has at least one third means to access at least one additional data base to provide at least one additional information to said at least one first professional service provider.

4. The apparatus for providing information over a network of claim 1, wherein said at least one first means for processing said information in said at least one central data base has at least one third means to access at least one additional data base to provide at least one additional information to said at least one first professional service provider, and wherein said additional information is selected from a group consisting of availability of parts, availability of supplies, price list of parts, price list of service, lead time for parts, address of said at least one first customer, contact information for said at least one first customer, and directions to work site requested by said at least one first customer.

5. The apparatus for providing information over a network of claim 1, wherein said at least one first means for processing said information in said at least one central data base has at least one third means to access at least one additional data base to provide at least one additional information to said at least one second professional service provider.

6. The apparatus for providing information over a network of claim 1, wherein said at least one first means for processing said information in said at least one central data base has at least one third means to access at least one additional data base to provide at least one additional information to said at least one second professional service provider, and wherein said additional information is selected from a group consisting of availability of parts, availability of supplies, price list of parts, price list of service, lead time for parts, address of said at least one first customer, contact information for said at least one first customer, and directions to work site requested by said at least one first customer.

7. The apparatus for providing information over a network of claim 1, wherein said second professional service provider makes a decision based on information provided by said at least one central data base on said at least one first customer.

8. The apparatus for providing information over a network of claim 1, wherein said at least one first professional service provider generates at least one first invoice using information from said at least one central data base for work done for said at least one first customer.

9. The apparatus for providing information over a network of claim 1, wherein said at least one central data base processes at least one payment for said at least one first professional service provider based on work done for said at least one first customer.

10. The apparatus for providing information over a network of claim 1, wherein said at least one central data base processes at least one payment for said at least one first professional service provider based on work done for said at least one first customer, and wherein said payment method is selected from a group consisting of PayPal, credit card payment, debt card payment, payment via a check, electronic payment, payment via electronic fund transfer, payment via cash, and combinations thereof.

11. The apparatus for providing information over a network of claim 1, wherein said at least one first means for processing said information in said at least one central data base has at least one third means to access at least one additional data base.

12. The apparatus for providing information over a network of claim 1, wherein said at least one first means for processing said information in said at least one central data base has at least one third means to access at least one additional data base, and wherein said at least one additional data base is selected from a group consisting of Facebook, Twitter, You Tube, Linked-In, YellowBook, YellowPages, WhitePages, business directories, customer listing data bases, Mapquest, Dun and Bradstreet, credit reporting companies, customer information providing data bases, and combinations thereof.

13. The apparatus for providing information over a network of claim 1, wherein said at least one first customer is selected from a group consisting of an individual, an organization, a company, and combinations thereof.

14. The apparatus for providing information over a network of claim 1, wherein said at least one first professional service provider is selected from a group consisting of a plumber, an electrician, a mason, a dentist, an attorney, an automobile mechanic, a car sales person, a service provider, and combinations thereof.

15. The apparatus for providing information over a network of claim 1, wherein said at least one first means for processing said information in said at least one central data base has at least one fourth means to display at least one ad.

16. The apparatus for providing information over a network of claim 1, wherein said at least one central data base has at least one means to restrict access to said at least one central data base.

17. The apparatus for providing information over a network of claim 1, wherein said at least one central data base has at least one means to restrict access to said at least one central data base, and wherein said at least one means to restrict access to said at least one central data base is selected from a group consisting of password protection means, security restriction means, and membership level means.

18. A method for providing information over a network comprising:
(a) connecting at least one central data base to said network, wherein said at least one central data base comprises of at least one first means for processing said information;
(b) providing at least one first input from at least one first professional service provider into said at least one central data base, wherein said at least one first input comprises of at least one first review based on first work done for at least one first customer;
(c) associating said at least one first review with said information using at least one second means in said at least one central data base;
(d) providing information to at least one second professional service provider upon request from said at least one second professional service provider based on information contained in said at least one central data base on said at least one first customer; and
(e) wherein said information provided to said at least one second professional service provider comprises of said at least one first review based on said first work done for said at least one first customer.

19. A program storage device readable by machine, tangibly embodying a program of instructions executable by the machine to perform method steps for providing information over a network, the method steps comprising:
(a) connecting at least one central data base to said network, wherein said at least one central data base comprises of at least one first means for processing said information;
(b) providing at least one first input from at least one first professional service provider into said at least one central data base, wherein said at least one first input comprises of at least one first review based on first work done for at least one first customer;
(c) associating said at least one first review with said information using at least one second means in said at least one central data base;
(d) providing information to at least one second professional service provider upon request from said at least one second professional service provider based on information contained in said at least one central data base on said at least one first customer; and
(e) wherein said information provided to said at least one second professional service provider comprises of said at least one first review based on said first work done for said at least one first customer.
